(19) United States
(12) Patent Application Publication
(10) Pub. No.: US 2006/0037843 A1
(43) Pub. Date: Feb. 23, 2006

(54) Device for dispensing parts, for example rivets, which are delivered at the outlet of a storage means such as a vibrating bowl, operating method thereof and adapted vibrating bowl

(76) Inventors: Jean-Marc Auriol, Les Blanches (FR); Philippe Bornes, Flourens (FR)

Correspondence Address: PENDORF & CUTLIFF, 5111 MEMORIAL HIGHWAY, TAMPA, FL, 33634-7356, US

(21) Appl. No.: 10/532,184

(22) PCT Filed: Oct. 21, 2003
(86) PCT No.: PCT/FR03/03113

§ 371 Date: Apr. 21, 2005

(30) Foreign Application Priority Data
Oct. 21, 2002 (FR) 0213346

(51) Int. Cl. B65G 27/02

(52) U.S. Cl. 198/757

(57) ABSTRACT

The invention relates to a device (D) for dispensing parts (R), e.g. rivets, which are delivered at the outlet of a storage means such as a vibrating bowl (100), said outlet (110) comprising a displacement path for the parts (R). The inventive device is characterized in that it comprises: a command unit (200) which authorises the individual passage of parts (R) being delivered by the storage and dispensing means (100) into a conduit (C), a control unit (300) which orients each part (R) passing through the conduit (C), and a suction means which is intended to drive the already-moving parts (R) individually into the conduit by accelerating the part (R) which is most affected by the vacuum. The invention also relates to the corresponding operating method and to the vibrating bowl which is adapted to one such device. The invention is suitable for dispensing parts such as rivets.

### BACKGROUND OF THE INVENTION

1. Field of the invention

The invention relates to the field of vibrating recipients and notably to the adjustments allowing for improved orientation and distribution of the parts released at the outlet of storage means and of unitary distribution such as vibrating recipients.

2. Related Art of the Invention

In the prior art there is a plurality of vibrating recipient type devices, such as the one disclosed in the American document No. 6,257,392, which use the same principle, that being the transmitting of vibrations to parts stored inside the recipient so that they follow a precise path allowing them to be released from said recipient, one after the other and most commonly touching the preceding part as well as the succeeding part.

Nevertheless, these recipients cannot propose, within the scope of the storage and distribution of asymmetric parts, systematic and reliable orientation of the part at the outlet of the recipient. The fact that the parts follow each other and generally touch both the preceding and succeeding parts adds to the difficulty of implementing a set orientation. However, this set orientation is especially beneficial notably for riveting applications for which the rivets must be delivered according to a predefined orientation, to a new storage device or a riveting device. Indeed, although it typically has a rotational symmetry, the rivets are also generally asymmetric with different diameters from one end to the other as they are typically made of a shank and a head. Some rivets, such as blind rivets have a shank on either side of the head, each shank serving a different function. Moreover, it is particularly important that the rivets are all oriented in the same manner so that they are delivered for example in respects to their direction of travel with their head to the rear of the riveting device.

Indeed, disorientation can result in poor riveting and possibly the damaging of the device used in the step following this preliminary distribution step at the outlet of the vibrating recipient. The ever possible risk of disorientation and damage to an actuator such as a drilling/riveting unit has led the designers of this type of device to multiply the control means along the path of the rivet down to the unit, which has increased the cost of such installations.

There are also several devices for turning a part inside a displacement installation for parts such as rivets, however, down to this day the proper positioning or orienting of parts such as rivets was only correctly detected at the end of displacement, that being in the vicinity of the drilling/riveting unit as it proves to be very difficult to detect the correct orientation of a rivet.

Among these devices, the one proposed in the American document No. 5,385,434 which discloses a distribution device from a storage means to an effector, of parts such as electric connector type parts which are different to rivets and most of all blind rivets. This device is remarkable in that it comprises:

distribution means connected to a distribution channel and implemented by a high-pressure jet allowing to create a differential pressure producing a suction effect resulting in the displacement on the inside of a channel of parts from the storage means to the effector,

unitary supply means located upstream of the distribution means and implemented via a rotary selector,

orientation means located upstream of the distribution means and implemented via a groove in which the parts are displaced which can only be oriented in one direction.

This device has the advantage of using compressed air to replace the use of gravity so as to supply the effectors and orient the parts for the effectors. This displacement of air also allows to displace the parts to be distributed from the storage means, which is not a vibrating recipient, to the distribution means.

### SUMMARY OF THE INVENTION

Based on this fact, the applicants carried out research to overcome these aforementioned inconveniences by proposing a solution likely to efficiently avoid disorientation of the parts released at the outlet of the storage means and of unitary distribution such as the vibrating recipients.

This research resulted in the designing of a distribution device for parts, notably rivets, released at the outlet of the storage means, such as vibrating recipients that are particularly advantageous and of simple construction, guaranteeing a properly oriented distribution of the released part.

According to the invention, the distribution device for parts, notably rivets released at the outlet of a means for storage such as a vibrating recipient which in the vicinity of its outlet has a displacement path for said parts, is remarkable in that it is constituted of:

a control module authorizing the unitary intake of parts released by said storage and distribution means on the inside of a channel,

a control module for orienting each part traveling through the channel, and

a suction means intended to drive the moving parts on the inside of the channel in a unitary manner by accelerating the part which is under the greatest depression.

This feature is especially advantageous in that it proposes the detecting of the orientation of the parts once they have been released from the vibrating recipient and prior to passing through the device that performs the following step, that being of distribution. The obtaining of reliable information allows to direct the part or rivet directly towards the following step in the same orientation as it was introduced into the channel or be directed towards a turning device in order to ensure it is turned and have the desired orientation.

The monitoring of the passing of parts prevents exceeding the capacity of the means for controlling the orientation.

Additionally, such a device can count the number of parts for which it monitored their orientation, which constitutes a particularly beneficial function in the framework of an intermediary processing step of the distributed parts.

The displacing of the parts inside the device is not ensured by a motorised means of displacement but by the displacing of air and therefore the exercising of depression in the channel via the suction means. The choosing of this displacement means is especially judicious in that it optimises the unitary passing of the parts inside the device. Indeed, the suction will only affect the part nearest the channel leaving the following part which is subject to lesser depression unmoved as it is further away and obstructed by the first part. The optimising of the airlock created by the control module at the inlet of the channel guarantees a unitary passing of the parts before the control module and consequently efficient detection of the orientation of said parts.

The distribution device of the invention differs to that proposed in the prior art in that it is located at the outlet of a vibrating recipient or an equivalent which, by definition, ensures the displacement of the parts it holds towards its outlet. Consequently, the parts received by the device of the invention are already moving. Therefore, the suction here does not put the parts into displacement but accelerates the displacement of the parts located at the far end of the outlet of the displacement path to be travelled along and guarantees a unitary intake into the distribution device itself subject to the vibrating of the recipient. The distribution device for parts released at the outlet of a vibrating recipient therefore fulfils other functions than those required by a distribution device of parts stored in a more typical recipient. It is the result of a permanent desire of the applicants searching to control the orientation of parts as far upstream as possible of the displacement circuit of the latter, that being in the vicinity of the storage means which, in this case, is a means of vibration.

The suction generated in the invention is therefore a means of accelerating the displacement of some parts already in motion, this suction guarantees that the parts under the greatest depression will be the first and only to enter the distribution device of the invention.

According to another particularly advantageous feature of the invention, the device of the invention is attached to the vibrating recipient to which it is associated. Thus, the device judicially uses the displacement of the parts typically performed by a vibrating recipient to bring the parts to the inlet of the channel.

The invention also relates to the operating method of such a device as well as the vibrating recipient appropriate for such a device. This vibrating recipient, bearing a displacement path for said parts in the vicinity of its outlet, is remarkable in that it is preformed, in a permanent manner, to receive the device of the invention.

The fundamental concepts of the invention being disclosed above in their most simplistic manner, other details and feature will become clearer upon reading the following description and in respect to the annexed drawings, given by way of non-restrictive example, an embodiment of a distribution device, of its operating method and of an appropriate vibrating recipient, according to the invention.

### BRIEF DESCRIPTION OF THE DRAWINGS

FIG. 1 is a schematic drawing of a perspective view of an embodiment of the distribution device according to the invention attached to a vibrating recipient.

FIG. 2 is a schematic drawing of a perspective view of the embodiment illustrated in FIG. 1 of the distribution device on its own.

FIGS. 3a, 3b, 3c and 3d are schematic drawings of a partial sectional top view of an embodiment of the device according to the invention illustrating its operating functions.

FIG. 4 is a schematic drawing of a partial sectional top view of an embodiment of the device according to the invention illustrating its operating functions using blind rivets to be distributed.

### DETAILED DESCRIPTION OF THE INVENTION

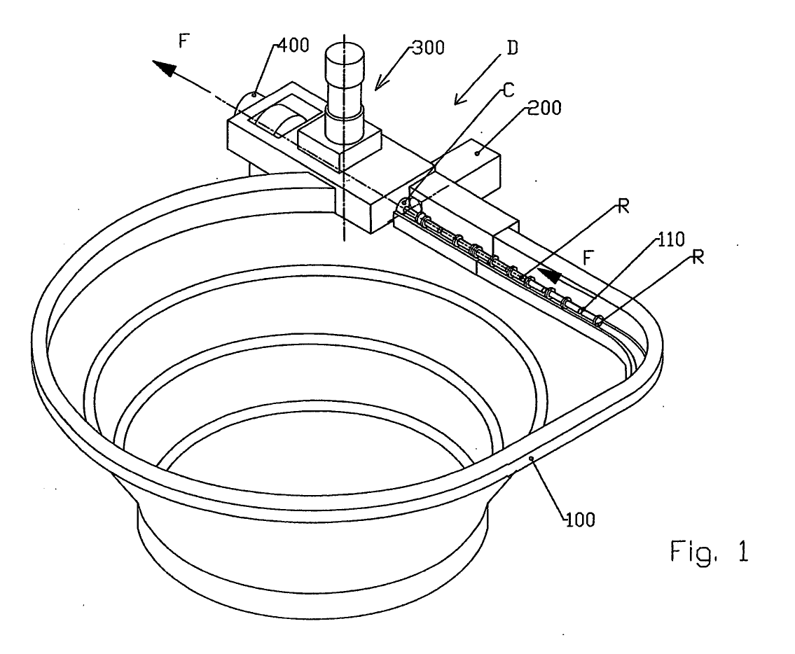

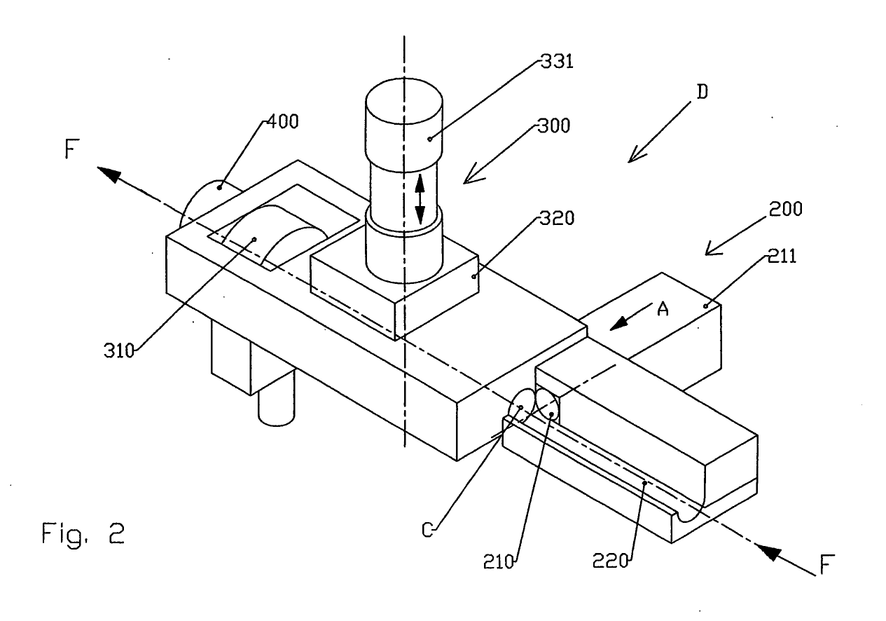

As illustrated in the drawings in FIGS. 1 and 2, the distribution device for parts of rotational symmetry, indicated through by D, notably of rivets indicated by R, released at the outlet of a storage means such as a vibrating recipient indicated by 100 which has a displacement path for said parts R in the vicinity of its outlet 110, is constituted of a control module 200 authorizing the unitary intake of the parts R released by said storage means 100 on the inside of a channel C and by a control module 300 for orientating each part R passing through the channel C.

According to the embodiment illustrated in FIG. 1, the device D is attached to the vibrating recipient 100 to which it is associated.

According to the invention, the device D comprises a suction means (not shown) aimed at directing the parts R to the inside of the channel C and ensuring their displacement on the inside. The parts R travel along the path illustrated by the arrows indicated by F which are here parallel to the axis of the channel C.

Indeed, as illustrated and according to the invention, the longitudinal axis of said channel C is placed in a coaxial manner to the axis of the parts R. Thus, the diameter of the channel is define so that the biggest diameter of the parts with rotational symmetry likely to be distributed in the recipient 100 can pass through.

According to the invention and as illustrated in greater detail in FIG. 2, said control module 200 is constituted of a first detection means (not shown) and of a movable element 210 located in front of the inlet of the channel C and whose displacement for the purpose of closing off the inlet of the channel C is controlled by the detection via said first detection means of the intake of a part R on the inside of the channel C. According to the invention, the parts R arrive by means of vibrations from the vibrating recipient at the inlet of the channel C which is put under depression with the aim of sucking the parts R. Thus, the displacement towards the device D is ensured by the vibrations of the recipient then on the inside of the channel in a unitary manner thanks to the depression created by the suction means.

To guide the passing through of the parts R towards the inlet of the channel C, the control module 200 advantageously comprises a ramp 220 upstream of the inlet of the channel C and extending beyond the displacement path preformed in the vibrating recipient 100 in the vicinity of its outlet 110.

Once a part R has entered the channel C, it is detected, the control module 200 actuates the movable element 210 in the direction of the arrow A in order to obstruct the inlet of the channel C guaranteeing the unitary passing through of the parts R on the inside of the device D avoiding any risk of jamming or poor detection of the orientation of the part R.

According to the invention, the movable control element 210 at the inlet of the channel C is actuated by a cylinder type means for displacing 211, the movable element 210 constituting the far end of the same shank of the latter (211). According to the illustrated embodiment, the axis of the shank of the cylinder 211 is perpendicular to the axis of the channel C, the exiting of the shank (arrow A) thus obstructing the inlet of the channel C, the inserting of the shank freeing it.

According to the invention, said control module 300 is constituted of a second detection means 310 placed right next to a retractable position retention means 320 of the part R inserted into the channel C, the absence or presence of a bit of the part R from the side of the position retention means 320 where the detection means 310 is located thus provides information relating to the orientation of the part R.

The far end corresponding to the outlet of the channel C is fitted with a connection 400 allowing to connect any routing means for the distributed parts and therefore the orientation has been detected.

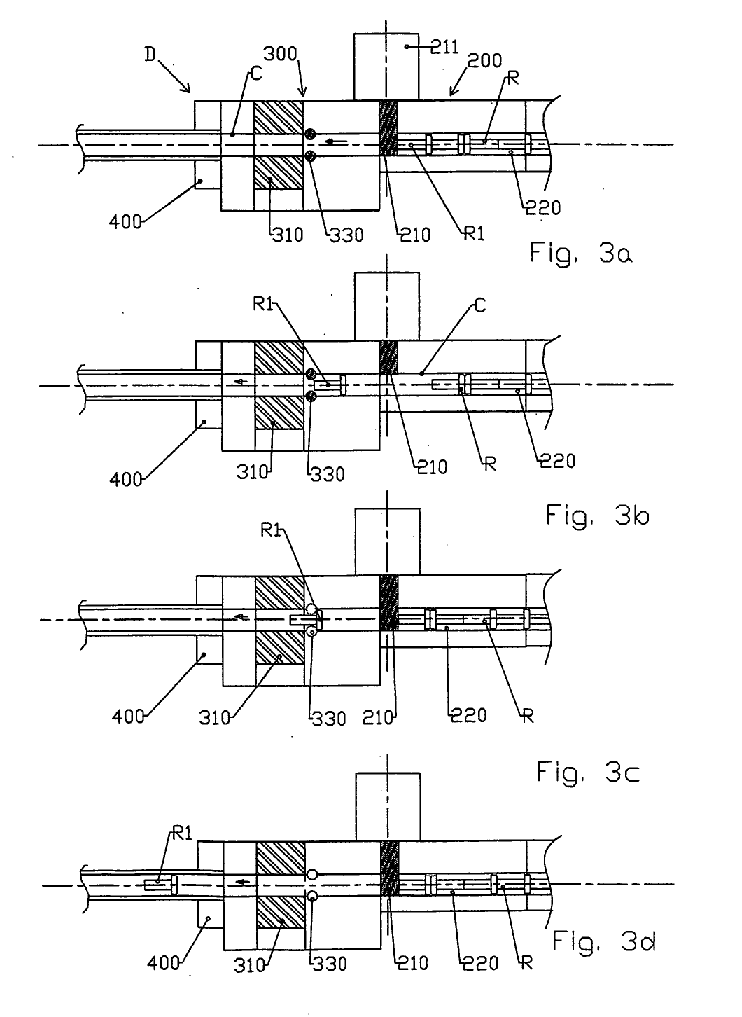

The operating of the device of the invention is illustrated in greater detail in the drawing in FIGS. 3a, 3b, 3c and 3d.

As illustrated, said position retention means 320 is constituted of a two-prong fork 330 lying on either side of the axis of the channel C which it obstructs and whose gap determines the diameter of the bit, likely to pass through, of the part R inserted into the channel C and coming into contact with the prongs 330 of the fork.

According to the illustrated embodiment, the position retention fork 330 is actuated by a cylinder type means for displacing 311 (see FIG. 2). The exiting of the shank allows the two prongs of the fork 330 to obstruct the channel C and the inserting of the shank allows to free the passageway. Thus, the movable control element at the inlet of the channel C as well as the position retention fork are each actuated by the cylinder type displacement means.

According to the invention, the above described operating method of the device associated with a means for turning the parts R located downstream of the distribution device D, consists, with the suction means in running mode and the fork 330 obstructing the channel C as illustrated in FIG. 3a:

in opening the inlet of the channel C by retracting the movable element 210 as illustrated in FIG. 3b thus activating the depression,

in letting the sucked part (which will be indicated by R1 for greater clarity) pass through which, already moving, is accelerated towards the channel C via suction;

in closing off the channel C via the returning of the movable element 210 when the passing through of the part R1 is detected in the channel C (as illustrated in FIG. 3c),

in detecting via the detection means 310 the presence or absence of a shank of part R1 downstream of the fork 330 once R1 is in contact with the prongs of the fork 330,

in retracting the fork 330 so as to let the part R1 pass through,

in channelling or not channelling the part R1 towards the turning means according to the desired orientation of the parts, and

in obstructing the channel C by means of the fork 330.

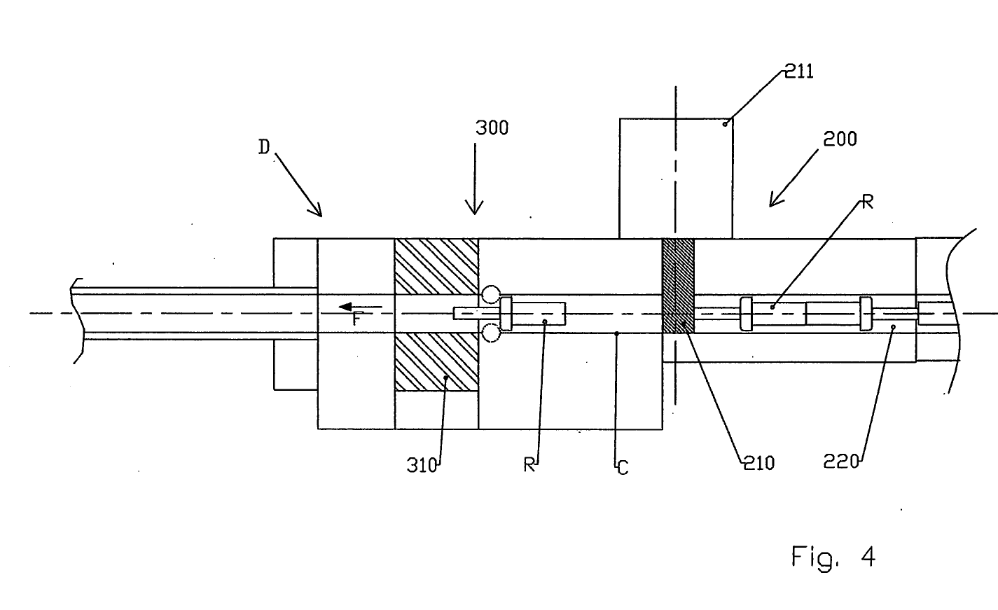

FIG. 4 illustrates an application for which the device is particularly well adapted and useful. Indeed, although the rivets with typical heads can be oriented for example via gravity thanks to the imbalance of the mass and/or volume between their shank and their head, it is not the case for blind rivets which have a shank of different diameter on either side of the head. The draw bar is that which has the smallest diameter. Thus, in order to distribute the blind rivets in a forward motion (relatively in the forward direction of the parts R illustrated by the arrow F) by means of the draw bar, the gap in the fork 330 is calculated so as to let the smallest diameter of the draw bar to pass through (as illustrated) and to prevent the largest diameter from passing through. Thus, once the fork 330 is obstructing the channel C, if the detector 300 detects the presence of a shank, it directs the part directly to the actuator that performs the following step and not to the turning device. On the contrary, if the detection module 310 does not detect the presence of a shank, then the draw bar is at the rear (relatively in the forward direction of the parts R illustrated by the arrow F) requiring it to be channelled towards the turning device.

FIG. 1 also illustrates an embodiment of a vibrating recipient 100 according to the invention bearing a displacement path for said parts R in the vicinity of its outlet 110 and remarkable in that it is preformed, in a permanent manner, to receive a device D constituted of a control module 200 allowing to intake, one at a time, the parts R released by said recipient 100 on the inside of a channel C, via a control module 300 for orientating each part R passing through the channel C and via a suction means aimed at directing the parts R to the inside of the channel C, the displacement path of said parts R being coaxial to said channel C.

We understand that the device, the method and the vibrating recipient, which have just been described above and represented, were planned to be divulged rather than restricted. Of course, other layouts, modifications and improvements can be made to the above example without leaving the scope of the invention such as is defined in the claims.

Thus, for example, the device of the invention can be materially separated from the vibrating recipient and simply remain connected by a parts delivery channel. Indeed, the device of the invention is sufficiently close to the outlet of the displacement path of the vibrating recipient so that the suction can accelerate the displacement of the first part located at the outlet and sufficiently distanced so that the vibrations of the vibrating recipient are not directly felt by the distribution device of the invention.

1. A distribution device (D) for parts (R) released at the outlet of a means for storage (100) which means for storage (100) in the vicinity of its outlet (110) has a displacement path for said parts (R), wherein the distribution device is constituted of:
a control module (200) authorizing the unitary intake of parts (R) released by said storage (100) and distribution means on the inside of a channel (C),
a control module (300) for orienting each part (R) traveling through the channel (C), and
a suction means intended to drive the moving parts (R) on the inside of the channel (C) in a unitary manner by accelerating the part (R) which is most affected by the vacuum.

2. The distribution device (D) according to claim 1, wherein the longitudinal axis of said channel (C) is placed in a coaxial manner to the axis of parts (R).

3. The distribution device (D) according to claim 1, wherein said control module (200) is constituted of a first detection means and of a movable element (210) located in front of the inlet of the channel (C) and whose displacement for the purpose of closing off the inlet of the channel (C) is controlled by the detection via said first detection means of the intake of a part (R) on the inside of the channel (C).

4. The distribution device (D) according to claim 1, wherein said control module (300) is constituted of a second detection means (310) placed right next to a retractable position retention means (320) of the part (R) inserted into the channel (C), the absence or presence of a bit of the part (R) from the side of the position retention means (320) where the detection means (310) is located thus provides information relating to the orientation of the part (R).

5. The distribution device (D) according to claim 4, wherein said position retention means (320) is constituted of a two-prong fork (330) lying on either side of the axis of the channel (C) which it obstructs and whose gap determines the diameter of the bit, likely to pass through, of the part (R) inserted into the channel (C) and coming into contact with the prongs (330) of the fork.

6. The distribution device (D) according to claim 3, wherein the movable control element (210) at the inlet of the channel as well as the position retention fork (330) are each actuated by the cylinder type displacement means (211 and 331).

7. The distribution device (D) according to claim 1 of the same type as the one associated with a vibrating recipient (100), wherein it is attached to the vibrating recipient (100) to which it is associated.

8. A method for operating a distribution device (D) for parts (R) released at the outlet of a means for storage (100) which means for storage (100) in the vicinity of its outlet (110) has a displacement path for said parts (R), wherein the distribution device is constituted of: a control module (200) authorizing the unitary intake of parts (R) released by said storage (100) and distribution means on the inside of a channel (C), a control module (300) for orienting each part (R) traveling through the channel (C), and a suction means intended to drive the moving parts (R) on the inside of the channel (C) in a unitary manner by accelerating the part (R) which is most affected by the vacuum associated with a means or turning the parts (R) located downstream of the device (D), wherein, with the suction means in running mode and the fork (330) obstructing the channel (C), it comprises:
in opening the inlet of the channel (C) by retracting the movable element (210),
letting the sucked part (R1) pass through;
closing off the channel (C) via the returning of the movable element (310) when the passing through of the part (R1) is detected in the channel (C),
detecting the presence or absence of a shank downstream of the fork (330),
retracting the fork (330) so as to let the part (R1) pass through,
channeling or not channeling the part (R1) towards the turning means according to the desired orientation of the parts, and
in obstructing the channel (C) by means of the fork (330).

9. (canceled)

10. A distribution device (D) for rivets dispensed at the outlet of a vibrating recipient storage means (100) which in the vicinity of its outlet (110) has a displacement path for said parts (R), wherein the distribution device is constituted of:
a control module (200) authorizing the unitary intake rivets released by said storage and distribution means (100) on the inside of a channel (C),
a control module (300) for orienting each rivet traveling through the channel (C), and
a suction means intended to drive the rivets on the inside of the channel (C) in a unitary manner by accelerating the rivet which is most affected by the vacuum.
